(19) United States
(12) Patent Application Publication
(10) Pub. No.: US 2009/0292091 A1
(43) Pub. Date: Nov. 26, 2009

(54) Method For Suspension Polymerization Of Polyvinyl Chloride With The Creation Of A Catalyst Directly In The Reactor And Stabilizing-Suspending Agent Added Thereto For Said Reaction

(76) Inventors: Gianni Benetta, Milano (IT); David Cathersides, Adria (IT)

Correspondence Address: ST. ONGE STEWARD JOHNSTON & REENS, LLC, 986 BEDFORD STREET, STAMFORD, CT, 06905-5619, US

(21) Appl. No.: 12/476,075

(22) Filed: Jun. 1, 2009

Related U.S. Application Data
(63) Continuation of application No. PCT/EP2007/010321, filed on Nov. 28, 2007.

(30) Foreign Application Priority Data
Nov. 30, 2006 (IT) UD2006A000248
Oct. 17, 2007 (IT) UD2007A000191

(51) Int. Cl. C08F 4/44; C08F 4/12; C09K 3/00

(52) U.S. Cl. 526/191; 526/226; 252/182.33

(57) ABSTRACT

Production method of polyvinyl chloride in an agitated reactor under pressure, including polymerization of vinyl monomers in aqueous suspension, of the type in which at least one vinyl monomer in aqueous solution is introduced into a reactor under agitation, having the following steps: a)—adding a stabilizing-suspending agent in hydroalcoholic suspension of an inorganic mineral powder containing at least magnesium and hydroxyl groups to said reactor, b)—adding to said reactor b1) a base; b2) a peroxide compound; b3) a chloroformate; and b4) an organic acid anhydride whereupon the separate addition of b1), b2), b3), b4), to form the reaction catalyst in situ is only and exclusively in said reactor in order to create said catalyst progressively and under the control of the addition of said stabilizing-suspending agent a).

### CROSS-REFERENCE TO RELATED APPLICATIONS

The present application is a continuation of pending International patent application PCT/EP2007/010321 filed on Nov. 28, 2007 which designates the United States and claims priority from Italian patent applications UD2006A000248 filed on Nov. 30, 2006, and UD2007A000191 filed Oct. 17, 2007, the content of which is incorporated herein by reference.

### FIELD OF THE INVENTION

The present invention relates to a method for suspension polymerization of polyvinyl chloride (PVC-S) with the creation of a catalyst directly in the reactor and contemporary use of a stabilizing-suspending agent whose characteristics correspond to the pre-characterizing part of the main claim.

The polyvinyl chloride obtained also forms a part of this invention.

### BACKGROUND OF THE INVENTION

The field of application is substantially aimed at the production of suspension polyvinyl chloride.

Polyvinyl chloride is understood to define a vinyl-based plastic material polymer, in particular from vinyl chloride monomer alone or together with other vinyl monomers, generally known with the abbreviation PVC or PVC-S.

The definition “stabilizing” is substantially understood as a stabilizing and/or control and/or containment and/or normalizing agent of the reaction, thus it is understood as an extremely broad and non-limitative definition of the function in the reaction and therefore also includes the thermal stabilization of the polymer.

More particularly the invention is aimed at the production of suspension polyvinyl chloride (PVC-S) by means of polymerization according to an “in situ” catalysis technique, namely the formation of the catalyst necessary for the polymerization reaction, therefore its creation directly inside the polymerization reactor.

### SUMMARY OF THE INVENTION

The definition “suspending” is explicitly understood as an agent that serves a function, possibly although not exclusively, to favour the suspension of solid particles in a liquid.

The definition “stabilizing-suspending” is understood as an agent having a primarily stabilizing function on the reaction and/or reaction temperature and only possibly and/or collaterally a suspending function, therefore said definition “stabilizing-suspending” is understood in the present description and claims as a general function pertaining to said polymerization.

The definitions “stabilizing”, “suspending” must also not be considered in combinations strictly limitative to the interpretation of the function of the product, since the material or product claimed and described can also have other functions not exactly forming part of such qualifications if not as in the most general interpretation as a component of the reaction with the creation of the catalyst in situ.

The use of catalytic systems or catalysts, such as products capable of generating free radicals in the reaction conditions, in suspension polymerization of vinyl chloride is known.

Over the years the use of classic catalysers from the fatty acid peroxide category, for example of the lauryl peroxide type, has been replaced by a new generation of catalyser products, defined as fast catalysers, such as peroxycarbonates, for example peroxycarbonate diisopropyl, that allow higher conversions from monomer to polymer and lower reaction times.

The following patents are cited as an example: U.S. Pat. No. 3,022,281, U.S. Pat. No. 3,108,093, U.S. Pat. No. 3,326,958, U.S. Pat. No. 3,420,807, U.S. Pat. No. 3,575,945, U.S. Pat. No. 3,580,955, U.S. Pat. Nos. 3,637,633, 3,821,273, U.S. Pat. No. 3,857,828, U.S. Pat. No. 3,984,386. In particular U.S. Pat. No. 3,575,945 discloses a process for the polymerisation of vinyl compounds using the stabilising suspending agent comprising magnesium.

These solutions also use hydrotalcite as stabilizing-suspending agents, well known as per the general formula

[M²⁺₁₋ₓM³⁺ₓ(OH)]^{s+}(Aⁿ⁻_{x/n})·mH₂O (1)
where:
M²⁺ represents a cation of a divalent metal chosen from the group of:
Mg, Ca, Sr, Ba, Zn, co, Mn or Ni
M³⁺ represents a cation of a trivalent metal chosen from the group of Al, B, Bi or Fe;
Aⁿ⁻ represents an anion with a valence comprised between 1 and 4 the examples including HCO₃⁻, OH⁻, F⁻, Cl⁻, I⁻, Br⁻, ClO₄⁻, CO₃²⁻, SiO₃²⁻, HPO₄²⁻,CH₃COO⁻, C₆H₅COO⁻
x and m are numbers that form part of the following limits:

0.2<x≦0.33

m>0.

For this purpose see U.S. Pat. No. 4,710,551 or JP61000207 (A) in the name of KYOWA CHEM IND CO LTD (JP).

The production methods of hydrotalcite-type compounds of formula (1) are described, for example in the Japanese patents N.32198/1972, 3760/1974, 29129/1976, 3353/1977,19555/1978 and 29893/1981.

The patent U.S. Pat. No. 4,710,551 claims a process for producing a polymer or copolymer of a vinyl chloride monomer with or without a comonomer by means of aqueous suspension polymerization or copolymerization in the presence of a suspension stabilizing agent and a polymerization initiator (catalyst) that is insoluble or slightly soluble in water and soluble in the monomer; the improvement comprising the carrying out of the polymerization or copolymerization in the presence of said suspension stabilizing agent that consists of a hydrotalcite-type compound of the aforementioned formula in which the hydrotalcite crystallites have an average diameter between 0.01 to 1 micrometer and where the amount of hydrotalcite compound is approximately between 0.05 to 5% in weight of the weight of the monomer or of the total weight of the monomer and the comonomer.

However, the use of this stabilizing-suspending agent has been suggested and has found some applications as claimed above only with systems in which provision is made for the priming of polymerization by means of previously prepared peroxides and therefore with a polymerization system that employs the addition of catalyst/s prepared previously that are generally from peroxides and therefore highly dangerous, unstable at certain temperatures, flammable and explosive.

Many attempts have been made to overcome such problems of directly producing in the reactor the catalyst necessary for the reaction but the practical applications have never been favourable so much so that this method has still not been adopted.

Catalyst production in the polymerization reactor is defined as “in situ” catalysis or “in situ” catalyzation, the definition of catalysis or catalyzation being understood as an action to facilitate the required reaction of the product from monomer to polymer, and the definition of “in situ” being understood as the action taking place in the reaction location, namely inside said reactor.

An example of in situ catalysis occurs when starting from an alkyl chloroformate+an oxidizing agent, occasionally also together with an anhydride, of the propionic anhydride type.

For this purpose see: U.S. Pat. No. 3,049,521, U.S. Pat. No. 3,637,633, U.S. Pat. No. 3,720,700, U.S. Pat. No. 3,978,032.

In particular be noted that U.S. Pat. No. 3,978,032 discloses a system working with very dangerous peroxigen compounds selected from organing peroxy acid (per acid) e.g. peracetic acid, and hydrogen peroxide and alkyl haloformiate, e.g. etil choloformiate (see description and abstract).

The formation of catalysts occurs by means of a reaction of the type:

chloroformate+hydrogen peroxide=percarbonate

whose formula is identified as follows:

2Cl—COOR+H2O2=R—O—CO—O—O—CO—O—R+HCl

and possibly:

(RCO)₂O+H₂O₂=RCOOOH+RCOOH

As it is possible to see, both reactions cause the production of acids, hydrochloric acid in particular, and can only occur in the presence of products capable of neutralizing said acids and shifting the equilibrium of the reaction in the desired direction.

Moreover, the level of alkalinity cannot be exceeded so as to avoid the decomposition of the chloroformates.

This also entails the need to use considerable quantities of buffer substances alongside the alkalis, such as for example generally bicarbonate of soda.

However, the use of the bicarbonate of soda pollutes the resulting product, namely the polyvinyl chloride that is obtained, which loses limpidity and physico-chemical characteristics such as for example transparency and electrical properties.

Industrial use has been limited by this limitation.

The process is however expensive.

Furthermore the following prior art documents are considered:
EP0623632 and GB1413173 disclosing a process for preparing vinyl chloride polymers in which the stabilizing suspending agent comprises magnesium.
U.S. Pat. No. 3,663,482 disclosing an aqueous suspension polymerisation process for vinil halides using organic acid anhydride.

### DETAILED DESCRIPTION OF THE INVENTION

The scope of the invention is to resolve the aforementioned problems and drawbacks and furthermore to:
improve the functionality and the performance of the reaction;
improve reliability, quality and safety of the reaction;
improve the quality of the resulting product,
reduce the production costs of the product.

Solution to the Problem and Identification of the Characteristics of the Invention

The problem is solved with the procedures that form part of the main claim, namely polyvinyl chloride is produced in an agitated reactor, by means of polymerization of vinyl monomers in aqueous suspension, using the following means:
a) use a suspension in a hydroalcoholic environment of an inorganic mineral powder containing at least magnesium and hydroxylic groups,
b) add to said reactor:
   b1) a base;
   b2) a peroxide compound
   b3) a chloroformate represented by ClCOOR₁
   b4) an organic acid anhydride represented by the general formula:

(R₂CO)₂O where R₂ is an alkyl radical comprised between C=1 and C=20.

in order to carry out the formation of the reaction catalyst in situ, by means of the separate addition of b1), b2), b3), b4), only and exclusively in said reactor so that said catalyst is created gradually and under the control of the addition of said stabilizing-suspending agent a).

The sub-claims represent advantageous preferred solutions that provide the best results.

Advantages

In this way it is possible to obtain the advantage of:
improving functionality and performance of the reaction;
improving reliability, quality and safety of the reaction;
improving the quality of the resulting product

In particular, with the presence of the stabilizing-suspending agent, according to the included claims, and with the antacid function dispersed in the mass subjected to reaction under agitation there is the advantage:
a) that the hydrochloric acid generated during the polymerization reaction and the formation of the catalyst is progressively neutralized as it forms, directly by said stabilizing-suspending component, by regulating and controlling, namely stabilizing in this way the reaction that occurs more regularly;
b) that it is possible to push the reaction approximately 4% more with respect to the reactions conducted without this method, without diverting from the product specifications by means of excess acidity and excessive final temperature increase;
c) that with the increase of the conversion, the quantity of monomer to be removed is reduced and this leads to a reduction in stripping times;
d) that the amount of foam produced is reduced, both during the reaction stage and during the final degassing/stripping stage;
e) that the use of the buffer is unnecessary, with the consequent reduction in the quantities of harmful salts present in the resin itself, thus improving the electrical properties of the PVC obtained;
f) that the PVC obtained has improved thermal stability, with the consequent reduction of stabilization costs during the compounding stage;
g) that the lower acidity of the reaction environment reduces attacking of the anti-dirt means that must not be reapplied before each reaction but must withstand 3-4 charges;
h) that there is greater security due to the fact that the preformed catalysts, that are dangerous and very difficult to process, are not manipulated and stored.

Description of Experimental Tests

In a pilot reactor, provided with an agitator, a barrier and a heating/cooling jacket, a series of charges have been carried out that will be distinguished as A type charges (normal), B type charges (normal but without buffer) and C type charges (according to the object of this invention):

A type charges

Are charged in the order:
water
polyvinyl suspending agents
NaOH solution
NaHCO₃
Vinyl chloride monomer=(VCM)
Alkyl chloroformate
Propionic anhydride (only for K≦65 values)

B type charges

Are charged in the order:
water
polyvinyl suspending agents
NaOH solution
Vinyl chloride monomer=(VCM)
Alkyl chloroformate
Propionic anhydride (only for K≦65 values)

C type charges

Are charged in the order:
water
polyvinyl suspending agents
stabilizing-suspending agent according to the present invention
NaOH solution
Vinyl chloride monomer=(VCM)
Alkyl chloroformate
Propionic anhydride (only for K≦65 values)

Data

The main product characteristics obtained with the three process types are indicated in the table enclosed.

| | A type charges | B type charges | C type charges |
|---|---|---|---|
| Conversion % | 86-88 | 40 | 90-92 |
| Final pH | 3.1-4.0 | 2.7-3.0 | 4.8-5.1 |
| Deposits | Normal | Very high | normal |
| Thermal Stability * | 9 | Indeterminable | 3 |
| Thermal Stability ** | 3′ | Indeterminable | 17′ |
| Transparency *** | Slightly | Indeterminable | Excellent |
| | opalescent | | |
| Anti-dirt treatment | Each charge | Each charge | Every 3 charges |
| Production cost and | Average with | Average with | Low with high |
| quality | average quality | average quality | quality |

* on a stabilized plate, in a Werner-Matisse dynamic oven at 180° C. Scale 1-10.1 = white 10 = black (completely degraded)
** To Congo red
*** on an Sn-stabilized plate

Advantageously the production process of PVC-S with K65 value is the following:

In a reactor complete with a suitable agitator, heating/cooling jacket, suitable for working under pressure, the following components are charged in the percentages and modalities reported below:

The charge volume equal to one hundred (100%) is calculated;

| | |
|---|---|
| 1^{st}) Demineralized water | 54.843% |
| 2^{nd}) 1^{st} Primary Suspending Agent (solution at 4%) | 0.020% |
| 3^{rd}) 2^{nd} Primary Suspending Agent (solution at 4%) | 0.002% |
| 4^{th}) Stabilizing Suspending Agent (suspension at 22%) | 0.090% |
| 5^{th}) Vinyl chloride monomer (VCM) | 45.000% |
| 6^{th}) Hydrogen peroxide (solution at 36%) | 0.010% |
| 7^{th}) Sodium hydroxide (solution at 30%) | 0.005% |
| 8^{th}) Ethyl chloroformate | 0.010% |
| 9^{th}) Propionic anhydride | 0.020% |

At this point the mass is heated until reaching the polymerization temperature equal to 60° C. and the temperature is maintained for the entire duration of the reaction.

Advantageously the production process of PVC-S with K70 value is the following:

In a reactor complete with a suitable agitator, heating/cooling jacket, suitable for working under pressure, the following components are charged in the percentages and modalities reported below:

The charge volume equal to one hundred (100%) is calculated;

| | |
|---|---|
| 1^{st}) Demineralized water | 56.504% |
| 2^{nd}) 1st Primary Suspending Agent (solution at 4%) | 0.028% |
| 3^{rd}) 2nd Primary Suspending Agent (solution at 4%) | 0.005% |
| 4^{th}) Stabilizing Suspending Agent (Suspension at 22%) | 0.129% |
| 5^{th}) Vinyl Chloride Monomer (VCM) | 43.315% |
| 6^{th}) Hydrogen Peroxide (solution at 36%) | 0.004% |
| 7^{th}) Sodium Hydroxide (solution at 30%) | 0.003% |
| 8^{th}) Ethyl Chloroformate | 0.012% |
| 9^{th}) Propionic Anhydride | 0.000% |

At this point the mass is heated until reaching the polymerization temperature equal to 54° C. and the temperature is maintained for the entire duration of the reaction.

Further advantages and innovative characteristics:

Advantageously, in order to increase the yield of the reactor, the polymerization water is introduced at a temperature already sufficiently high to reach, at the end of the charging of water the itself, the specific polymerization temperature that ranges from 50° C. to 75° C.

With this system reactor heating times are shortened thus saving all the down time necessary for bringing the reactor from room to polymerization temperature, consequently increasing the productive capacity of the reactor itself.

Such a technique does not present difficulties when it is used in collaboration with traditional catalysts (slow) however when fast catalysts are used a series of problems is usually encountered. In fact, fast catalysts placed in contact with water at a high temperature (generally≧90° c.) instantly generate a high number of active radicals that partly self-destruct, re-combining themselves, and partly produce glassy and/or low molecular weight polymer particles.

Then, when one wishes to use the catalysts formed “in situ” rather than use the preformed fast catalysts, the problem is aggravated further since the components of the system used for the production of the catalyst (generally a peroxide and a chloroformate) are extremely unstable and decompose faster the higher the temperature.

The result is an irregular reaction and significant difficulty in the homogenous distribution of radicals in the polymer particles with a consequent non-homogeneity in terms of granulometry, porosity and molecular weights in the polymer itself.

Surprisingly it has been stated that none of the aforementioned problems appears when the high temperature water introduction technique is used with the formulations that are the object of the present invention.

During one of the laboratory tests, the aforementioned components are charged in the sequence reported below:
1 Primary suspending agent 1
2 Primary suspending agent 2
3 Stabilizing system REAPAK,
4 Vinyl Chloride Monomer (VCM)
5 Water at a high temperature
6 First component of the catalytic system “IN SITU”
7 Second component of the catalytic system “IN SITU”
8 Third component of the catalytic system “IN SITU”
9 Fourth component quarter of the catalytic system “IN SITU”

In this case:
a) the primary suspending agent I pertains to the polyvinyl alcohol group, with a level of hydrolysis between 95 and 66, preferably 88, and is used in a quantity between 1000 and 100 ppm on the quantity of VCM, preferably 500ppm;
b) The primary suspending agent II belongs to the polyvinyl alcohol group, with a level of hydrolysis between 80 and 60, preferably 72, and is used in a quantity between 2000 and 500 ppm on the quantity of VCM, preferably 1000 ppm;
c) The stabilizing system REAPACK is described in the patent PCT/EP2006/050679 and is used in a quantity between 3000 and 500 ppm on the quantity of VCM, preferably 2000ppm;
d) The VCM is charged in a ratio between 1/3 and 1/0.5 w/w of water, preferably 1/1 w/w
e) For a polymerization temperature of 59° C., the water is charged between 98° C. and 85° C., preferably 95° C.
f) The first component of the catalytic system is an Anhydride, preferably Propionic Anhydride, in a quantity equal to between between 1500 and 500 ppm, preferably 700 ppm;
g) The second component of the catalytic system is a basic reagent, preferably NaOH, Sodium Hydroxide in a quantity equal to between 1000 and 100 ppm on the quantity of VCM, preferably 200 ppm;
h) The third component of the catalytic system is a peroxide, preferably hydrogen peroxide, in a quantity equal to between 1000 and 100 ppm, preferably 200 ppm;
i) The last component of the catalytic system is chloroformate, preferably Ethyl Chloroformate, in a quantity equal to between 1500 and 200 ppm, preferably 400 ppm
Proceeding in the way described above the reaction immediately begins and all the time normally spent heating the reactor are saved; for reactors with large dimensions (100 mc) it is possible to estimate a time saving of approximately 1.5-2.0 hours.

In fact with this procedure, the times are reduced to the limited time needed to charge the hot water, and therefore only depend on the capacity of the water-charging pump.

This “IN SITU” catalysis technology with hot or cold charging as well as the benefits from reduction of reaction times, hot charging, cost reduction of the catalytic system and reduction of the use of anti-dirt agents aids the effectiveness of the process and therefore there is an improved quality of the S-PVC, more homogenous granulometry, more homogenous porosity, more constant pore dimensions and numbers and improved mechanical characteristics in terms of thermal stability.

1. A in situ process for production of polyvinyl chloride in a pressurized agitated reactor by means of polymerization of vinyl monomers in aqueous suspension comprising the steps of:
adding at lest one vinyl monomer in aqueous solution into a pressurized agitated reactor;
adding a stabilizing-suspending agent in hydroalcoholic suspension of an inorganic mineral powder having magnesium and hydroxylic groups to said reactor;
adding,
b1) a base;
b2) a peroxide compound represented by A₂O₂ where A=H or Na;
b3) a chloroformate represented by ClCOOR₁; and
b4) an organic acid anhydride represented by the general formula:
(RCO)₂O where R is an alkyl radical comprised between C=1 and C=20, to said reactor;
adding aluminium with hydroxylic groups to said reactor;
wherein in order to carry out the formation of the reaction catalyst in situ the separate addition of b1), b2), b3), b4), is performed only and exclusively within said reactor so that said catalyst is created gradually and under the control of the addition of said stabilising-suspending agent;
and
wherein said magnesium and hydroxylic groups of said stabilizing-suspending agent have a weight percentage between 4-12%, and
said aluminium and hydroxylic groups have a weight percentage between 2-8%.

2. The process of claim 1, wherein the magnesium and hydroxylic groups have a weight percentage between 7-8%.

3. The process of claim 1, wherein the aluminium and hydroxylic groups have a weight percentage of approximately 4%.

4. The process of claim 1, wherein the magnesium and hydroxylic groups have a weight percentage between 7-8% and the aluminium and hydroxylic groups have a weight percentage of approximately 4%.

5. The process of claim 1, wherein the reaction stabilizing-suspending agent further has zinc.

6. The process of claim 1, said stabilizing-suspending agent includes hydrotalcite having the formula:
[M²⁺_{1 -x}M³⁺ₓ(OH )]^{x+}(Aⁿ⁻_{x/n})·mH₂O
where:
M²⁺ represents a cation of a divalent metal chosen from the group of: Mg, Ca, Sr, Ba, Zn, Co, Mn or Ni;
M³⁺ represents a cation of a trivalent metal chosen from the group of Al, B, Bi or Fe;
Aⁿ⁻ represents an anion with a valence between 1 and 4 the examples include HCO₃⁻, OH⁻, F⁻, Cl⁻, I⁻, Br⁻, ClO₄⁻, CO₃²⁻, SiO₃²⁻, HPO₄²⁻,CH₃COO⁻, C₆H₅COO⁻; and
x and m are numbers that form part of the following limits:
0.2<x≦0.33
m>0, wherein said hydrotalcite is in suspension in a hydroalcoholic environment.

7. The process of claim 6, wherein the said hydroalcoholic environment is a hydroalcoholic solution with polyvinyl alcohols of weight ratio of between 10% and 30% of hydrotalcite.

8. The process of claim 6, wherein said hydrotalcite has a weight ratio of approximately 20% of said solution.

9. The process of claim 6, wherein said hydroalcoholic environment is a hydroalcoholic solution with polyvinyl alcohols with a ratio of approximately 50% pp+−10%.

10. The process of claim 1, wherein the inorganic powder takes the form of microparticles with diametral dimensions of between 500 and 1000 Angstrom.

11. The process of claim 1, wherein the inorganic powder takes the form of microparticles with diametral dimensions comprised between 700 and 800 Angstrom.

12. The process of claim 1, wherein the base b1) is NaOH.

13. The process of claim 1, wherein the base b1) is Na4OH.

14. The process of claim 6, wherein A in the peroxide compound is hydrogen (H).

15. The process of claim 6, wherein A in the peroxide compound is sodium (Na).

16. The process of claim 6, wherein R in the chloformate is selected from a group consisting of Methyl-, Ethyl, Isopropyl-, m-Propyl-, or 2-ethyl hexyl-.

17. The process of claim 1, wherein the anhydride of b4) is propionic.

18. The process of claim 1, wherein the anhydride of b4) is isopropionic.

19. The process of claim 1, wherein the at least one vinyl monomer is vinyl chloride monomer (VCM).

20. The process of claim 1, wherein the at least one vinyl monomer is vinyl chloride monomer (VCM) together with vinyl acetate (Vac).

21. The process of claim 1, wherein the process is conducted at a temperature between 40 and 75° C.

22. The process of claim 1, wherein the stabilizing-suspending agent is between 0.4 to 0.8% of the weight of the at least one monomer.

23. The process of claim 1, wherein the stabilizing-suspending agent approximately 0.6% of the weight of the at least one monomer.

24. The process of claim 1, wherein the use of buffer stabilizing-suspending agents is excluded.

25. The process of claim 1, wherein the reactor is complete with a suitable agitator and heating/cooling jacket and is suitable for pressurised working, and wherein the following components are charged in the region of the percentages and the modalities reported below:
a) the volume charge equal to one hundred (100%) of the added elements according to the following parameters is calculated:
1^{st}) Demineralized water 54.843%;
2^{nd}) 1^{st} Primary Suspending Agent (solution at 4%) 0.020%;
3^{rd}) 2^{nd} Primary Suspending Agent (solution at 4%) 0.002%;
4^{rd}) Suspending Stabilizing Agent (suspension at 22%) 0.090%;
5^{th}) Vinyl Chloride Monomer (VCM) 45.000%;
6^{th}) Hydrogen Peroxide (solution at 36%) 0.010%;
7^{th}) Sodium hydroxide (solution at 30%) 0.005%;
8^{th}) Ethyl chloroformate 0.010%;
9^{th}) Propionic anhydride 0.020%;
and b) the mass is heated until reaching 60° C., wherein the temperature is maintained for the entire duration of the reaction.

26. The process of claim 1, wherein the reactor is complete with a suitable agitator and heating/cooling jacket and is suitable for pressurised working, and wherein the following components are charged in the region of the percentages and the modalities reported below:
a) the charge volume equal to one hundred (100%) of the added elements is calculated according to the following parameters:
1^{st}) Demineralized water 56.504%
2^{nd}) 1^{st} Primary suspending agent (solution at 4%) 0.028%
3^{rd}) 2^{nd} Primary suspending agent (solution at 4%) 0.005%
4^{th}) Suspending Stabilizing Agent (suspension at 22%) 0.129%
5^{th}) Vinyl Chloride Monomer (VCM) 43.315%
6^{th}) Hydrogen Peroxide (solution at 36%) 0.004%
7^{th}) Sodium hydroxide (solution at 30%) 0.003%
8^{th}) Ethyl chloroformate 0.012%
9^{th}) Propionic Anhydride 0.000%
and b) the mass is heated until reaching 60° C. and the temperature is maintained for the entire duration of the reaction.

27. The process of claim 25 characterised in that said environment is between 10%.

28. The process of claim 1, wherein polymerization water is introduced at a temperature already sufficiently high to reach, at the end of the charging of water the itself, the specific polymerization temperature is in the range of approximately 50° C.-75° C.

29. The process of claim 28, characterised in that the following parameters are used:
a) the primary suspending agent belongs to the polyvinyl alcohol group, with a level of hydrolysis between 95 and 66, preferably 88, and is used in a quantity between 1000 and 100 ppm on the quantity of VCM, preferably 500 ppm;
b) the primary suspending agent II belongs to the group of polyvinyl alcohols, with a level of hydrolysis between 80 and 60, preferably 72, and is used in a quantity between 2000 and 500 ppm on the quantity of VCM, preferably 1000 ppm;
c) the stabilizing agent is used in a quantity between 3000 and 500 ppm on the quantity of VCM, preferably 2000 ppm;
d) the VCM (vinyl chloride monomer) is charged in a ratio between 1/3 and 1/0.5 w/w to water, preferably 1/1 w/w
e) with a polymerization temperature of approximately 59° C., the water is charged between 98° C. and 85° C., preferably 95° C.
f) the first component of the catalytic system is an Anhydride, preferably Propionic Anhydride, in a quantity equal to between 1500 and 500 ppm, preferably 700 ppm;
g) the second component of the catalytic system is a basic reagent, preferably NaOH, Sodium Hydroxide in a quantity equal to between 1000 and 100 ppm on the quantity of VCM, preferably 200 ppm;
h) the third component of the catalytic system is a peroxide, preferably hydrogen peroxide, in a quantity equal to between 1000 and 100 ppm, preferably 200 ppm; and
i) the last component of the catalytic system is chloroformate, preferably Ethyl chloroformate in a quantity equal to between 1500 and 200 ppm, preferably 400 ppm.

30. Polyvinyl chloride obtained via the in situ polymerization process of claim 1 having magnesium and hydroxylic groups.

31. Polyvinyl chloride obtained via the in situ polymerization process of claim 1 having aluminium and hydroxylic groups.

32. Polyvinyl chloride obtained via the in situ polymerization process of claim 1 having magnesium, aluminium and hydroxylic groups.

33. A reaction stabilizing-suspending agent for carrying out in situ polymerization comprising hydrotalcite having the formula:
[M²⁺₁₋ₓM³⁺ₓ(OH )]^{x+}(Aⁿ⁻_{x/n})·mH₂O
where:
M²⁺ represents a cation of a divalent metal chosen from the group of: Mg, Ca, Sr, Ba, Zn, Co, Mn or Ni;
M³⁺ represents a cation of a trivalent metal chosen from the group of Al, B, Bi or Fe;
Aⁿ⁻ represents an anion with a valence between 1 and 4 the examples include HCO₃⁻, OH⁻, F⁻, Cl⁻, I⁻, Br⁻, ClO₄⁻, CO₃²⁻, SiO₃²⁻, HPO₄²⁻,CH₃COO⁻, C₆H₅COO⁻; and
x and m are numbers that form part of the following limits:
0.2<x≦0.33
m>0 , wherein said hydrotalcite is in suspension in a hydroalcoholic environment.

34. The stabilizing-suspending agent of claim 33 wherein said hydroalcoholic environment is a hydroalcoholic solution with polyvinyl alcohols of weight ratio of between 10% and 30% of hydrotalcite.

35. The stabilizing-suspending agent of claim 34, wherein said hydrotalcite has a weight ratio of approximately 20% of said hydroalcoholic solution.

36. The stabilizing-suspending agent of claim 33, wherein said hydroalcoholic environment is a hydroalcoholic solution with polyvinyl alcohols with a ratio of approximately 50% pp+−10%.
